(19) United States
(12) Patent Application Publication
(10) Pub. No.: US 2014/0279486 A1
(43) Pub. Date: Sep. 18, 2014

(54) SYSTEM AND METHOD FOR GUARDING AGAINST FRAUDULENT DIRECT DEPOSIT ENROLLMENTS IN AN ISSUER-EFFECTUATED ENROLLMENT SYSTEM

(71) Applicant: PREPAID RESOURCES, LLC, New York, NY (US)

(72) Inventor: Barry Kessler, New York, NY (US)

(73) Assignee: PREPAID RESOURCES, LLC, New York, NY (US)

(21) Appl. No.: 13/841,018

(22) Filed: Mar. 15, 2013

(51) Int. Cl. G06Q 20/40; G06Q 20/22

(52) U.S. Cl. CPC G06Q 20/4016; G06Q 20/22
USPC 705/42

(57) ABSTRACT

Systems and methods disclosed herein provide improved security against fraudulent direct deposit enrollments in an issuer-effectuated direct deposit enrollment system. By providing visibility across multiple account products and issuers, the system is able to detect fraudulent enrollments and create negative lists that may be shared among, and utilized by, multiple issuers.

### BACKGROUND OF THE INVENTION

1. Field of the Invention

This application relates to providing and securing direct deposit enrollment services from fraudulent enrollments. In particular, this application relates to a system and method for detecting and combating possible instances of identity theft while, at the same time, allowing third parties such as card issuers and program administrators to facilitate direct deposit enrollment of accountholder customers.

2. Description of the Related Art

The ability for consumers to access direct deposit of their benefits payments has become increasingly important in recent years. The U.S. Treasury has successfully converted the majority of its paper-based benefit recipients to its DirectExpress® MasterCard® prepaid debit card. On Mar. 1, 2013, the federal government “went completely paperless” generally no longer issuing federal benefits via a paper check. Likewise, most States now disburse unemployment and other benefit entitlements via prepaid cards. Consumers wishing to transfer these payments to an account of their choice can only do so by authorizing a direct deposit transfer. Banks, credit unions and prepaid card providers (“account issuers”), in their quest to attract and serve these customers, need a means to initiate and manage the direct deposit process. Because of this, the inventors of this application have previously devised improved systems and methods for method of automating enrollment of direct deposits from a payor to a payee's deposit account by allowing third parties, such as account issuers to easily initiate direct deposit enrollments on behalf of accountholders. These methods are described in U.S. Patent Publication No. 2011-0288991, the entire disclosure of which is incorporated by reference herein it is entirety.

Because more and more business is transacted online and electronically, identity theft has become a serious problem. Specifically, fraudsters are utilizing stolen identities to open deposit accounts, redirect payments, and access those redirected funds. Although various technologies have been developed to combat this problem, they have proven insufficient the number of incidents of identity theft continues to grow. Accordingly, improved ways of combating identity theft are needed to prevent fraudulent direct deposit enrollments.

### SUMMARY

In one embodiment, a method of detecting fraudulent direct deposit enrollments is provided. The method includes receiving and storing personal data regarding the enrolling accountholder from a plurality of account holders on behalf of multiple account issuers.

In one embodiment, a method of detecting fraudulent direct deposit enrollments is provided. The method includes receiving and storing personal data regarding the enrolling accountholder and verifying said data against public record information to verify the identity of that accountholder. This method further includes receiving and storing personal data regarding the related beneficiary and verifying said data against public record information to verify the identity of that beneficiary. This method further includes blocking the enrollment where the identity of the account holder or beneficiary is not verifiable, advising the account issuer of the block and storing additional data indicative of the blocked enrollment and the affected account, account holder and beneficiary.

In another embodiment, a method of detecting fraudulent direct deposit enrollments is provided. The method includes systematically analyzing enrollment data received for conformity with identified historical fraudulent enrollment patterns. This method further includes blocking the enrollment where the systems identify a likelihood of fraud, advising the account issuer of the block and storing additional data indicative of the blocked enrollment and the affected account, account holder and beneficiary,

In another embodiment, a method of detecting fraudulent direct deposit enrollments is provided. The method includes maintaining a database of accounts, accountholders, and beneficiaries identified and affected by fraudulent activities described in the embodiments above. This method further includes blocking enrollments associated to any affected account, account holder and beneficiary,

In still another embodiment, a method of detecting fraudulent direct deposit enrollments is provided. The method includes maintaining a database of accounts, accountholders, and beneficiaries identified and affected by the fraudulent activities described in the embodiments above. This method further includes blocking enrollments associated to any affected account, account holder and beneficiary,

In yet another embodiment, a method of detecting fraudulent direct deposit enrollments is provided. The method includes utilizing the embodiments described above to systematically assess enrollments across portfolios of the stored enrollment data of multiple account issuers to protect an account issuer from exposure to fraudulent enrollment activity previously perpetrated on another account issuer. The method further includes blocking the enrollment and storing additional data indicative of the blocked enrollment and the account, account holder and beneficiary if prior blocked benefit enrollment requests exist.

In another embodiment, a method of detecting fraudulent direct deposit enrollments is provided. The method includes receiving and storing data regarding the requested the amount and timing of the requested direct deposit and, subsequent to the processing of that direct deposit request, verifying the correlation between the requested direct deposit parameters to the actual direct deposit parameters received. The method further includes enabling the account issuer to review the legitimacy of incoming direct deposits prior to its posting to the requesting accountholder's account and to suspend deposits with identified inconsistencies for further review or return to the payor.

In another embodiment, a method of detecting fraudulent direct deposit enrollments is provided. The method further includes enabling the account issuer to review the legitimacy of incoming direct deposits associated to accounts, accountholders, and beneficiaries associated by the system to fraudulent activity and to suspend these deposits for further review or return to the payor.

### BRIEF DESCRIPTION OF THE DRAWINGS

FIG. 1 is a block diagram of one example of a computing device that may be used in accordance with one or more embodiments.

FIG. 2 is a high-level network diagram of one example of an automated issuer-effectuated direct deposit system in accordance with one or more embodiments.

FIG. 3 is a more detailed view of the direct deposit enrollment system shown in FIG. 2.

FIG. 4 is a more detailed view of the direct deposit enrollment application server shown in FIG. 3.

FIG. 5 is a more detailed view of the enrollment protocol shown in FIG. 4.

FIG. 6 is a more detailed view of the enrollment data shown in FIG. 3.

FIG. 7 is a more detailed view of the fraud protection module shown in FIG. 4.

FIG. 8 is a more detailed view of the enrollment blocking module shown in FIG. 7.

FIG. 9 is a more detailed view of the fraud data storage shown in FIG. 8.

FIG. 10 is a high-level flow diagram showing one example of a process for a multi-tiered approach to detecting fraudulent direct deposit enrollments.

FIG. 11 is a flow diagram illustrating a process for collecting information regarding blocked direct deposit enrollment requests made by account holders for benefits.

FIG. 12 is a flow diagram illustrating a process for using the data collected in FIG. 11 to detect fraudulent direct deposit enrollment attempts across multiple account issuers.

### DETAILED DESCRIPTION OF CERTAIN INVENTIVE EMBODIMENTS

Embodiments disclosed herein relate to a multi-tiered approach to protection against fraudulent direct deposit enrollment activity. A issuer-effectuated direct deposit enrollment system integrated third party verification services into the enrollment platform to prescreen prospective enrollments. The account issuer is provided an interface through which enrollment blocking criteria may be defined according to the needs of the account issuer. Enrollment data is analyzed in view of the enrollment blocking criteria associated with the account issuer. The results of the analysis are stored and made visible across multiple account products and issuers, and a list of suspicious accounts are flagged and made available to multiple account issuers to prevent repeated attacks.

The inventors of the systems and methods disclosed herein have recognized that their issuer-effectuated direct deposit enrollment platform provides a degree of visibility across multiple account issuers and their multiple account products which allows for the detection of fraudulent activity that is otherwise difficult to detect. In particular, the issuer-effectuated direct deposit enrollment platform allows for the ability to apply uniform screening parameters across multiple account products and account issuers, as well as giving the ability to leverage enrollment visibility in order to identify suspicious activities. Thus, by monitoring enrollment activity across different account issuers and different products the systems disclosed herein are able to generate cross-issuer “negative lists”; the findings of which can be communicated amongst various Account issuers in order to prevent multiple attacks on the part of identity thieves.

As noted above, the systems and methods disclosed herein may be implemented in the context of an issuer-effectuated direct deposit enrollment computer system. FIG. 1 is a block diagram of one example of a computer system that may be utilized in the implementation of certain embodiments of the invention. Turning to FIG. 1, an example is provided of a computer system 100 suitable for practicing various embodiments of the invention. The computer system 100 may generally take the form of computer hardware configured to execute certain processes and instructions in accordance with one or more embodiments described herein. The computer hardware may be a single computer or it may be multiple computers configured to work together. The computer system 100 includes a processor 102. The processor is generally configured to execute computer instructions to carry out certain tasks related to providing direct deposit enrollment services. The processor 102 may be a standard personal computer processor such as those distributed by Intel, Advanced Micro Devices or Motorola. The processor 102 may also be a more specialized processor tailored for banking processes and programs. The system 100 may also include memory 104. The memory 104 may include volatile memory 104A such as some form of random access memory. The volatile memory 104A may be configured to load executable software modules into memory so that the software modules may be executed by the processor 102 in a manner well known in the art. The software modules may be stored in a non-volatile memory 104B. The non-volatile memory 104B may take the form of a hard disk drive, a flash memory, a solid state hard drive or some other form of non-volatile memory. The non-volatile memory 104B may also be used to store non-executable data, such database files and the like.

The computer system 100 also may include a network interface 106. The network interface may take the form of a network interface card and its corresponding software drivers and/or firmware configured to provide the system 100 with access to a network (such as the Internet, for example). The network interface card 106 may be configured to access various different types of networks. For example the network interface card 106 may be configured to access private networks that are not publicly accessible. The network interface card 106 may also be configured to access wireless networks such using wireless data transfer technologies such as EVDO, WiMax, or LTE network. Although a single network interface card 106 is shown in FIG. 1, multiple network interface cards 106 may be present in order to access different types of networks. In addition, the network interface card 106 may be configured to allow access to multiple different types of networks.

An operating system 108 is also included in the computer system 100. The operating system 108 may be a well-known general operating system such as Linux, Windows, ChromeOS, or MacOS which is designed to provide a platform from which computer software applications may be executed by the processor 102. Alternatively, the operating system 108 may also be a special purpose operating system designed specifically for the network-based banking applications. Running on the operating system 108 may be web server software 110. The web server software 110 may be a standard off the shelf web server product such as Apache, Internet Information Server, or some other web server software. Alternatively, the web server may form a part of the operating system 108, or it may be a specialized HTTP server which is configured specifically to deliver banking related web pages to browsing software via a network such as the Internet, or some other local area network or wide area network. The web server software 110 may be stored in the memory 104 for access by the processor 102 to execute on the operating platform provided by the operating system 108.

The computer system, 100 further may include an application server 112. The application server 112 may include computer hardware and/or software which is configured to provide network-based applications which may run natively on the computer system 100, or be accessed via the web server 110, or both. The application server may be configured to allow for the distribution, use, and maintenance of a direct deposit enrollment system that will be discussed in detail below.

Various embodiments of the invention may be implemented across one or more networks. FIG. 2 is an example of a network environment suitable for practicing various embodiments described herein. The network environment 200 includes one or more networks 200. The network 220 may be a wide area network such as, for example, the Internet. The network 220 may also include a series of more localized networks, such as virtual private networks, or the like. The network 220 may also be a combination of private networks and public networks. In some embodiments, the network 220 is configured to support secure communications as is known in the art. For example, the network 220 may include a series of routers and other communications hardware and software which support various forms of encrypted communications. The network environment 200 may include various parties and systems which are in communication with each other via the network 220 in order to receive and/or provide direct deposit enrollment services.

For example, the network environment 200 may include an accountholder/payee 202. As used herein, the accountholder/payee 202 refers to a person or entity that is entitled to receive a payment and possesses a deposit account which can receive the payment. The payment is generally owed to the accountholder/payee 202 by a payor 208. As used herein, a payor 208 is a person or entity which makes a payment to the accountholder/payee 202. The accountholder/payee 202 may be an individual person, or it may be a business entity such as a corporation or a partnership. The payor 208 may be any of a variety of different types of entities. In one embodiment, the payor 208 may be the federal government, and the payment owed to the accountholder/payee 202 may be a federal benefit. In another embodiment, the payor 208 may be an employer, and the payment owed to the accountholder/payee may be a paycheck or some other payment. In other embodiments, the payor 208 may be a pension provider, and the payment owed to the accountholder/payee may be an annuity. In still another embodiment, the payor 208 may be a state or local government, and the payment owed to the accountholder/payee 202 may be a state or local benefit.

As noted above, systems and methods of disclosed embodiments relate to providing automatic direct deposit enrollment for accountholder/payees 202 in order to facilitate the payments made by the payor 208 to be directly deposited into one or more specified accounts. The accountholder/payee 202 may have one or more deposit accounts 204. The deposit account 204 may be viewed and transactions may be conducted via the network 220. The deposit account 204 may take various forms. The deposit account 204 may be a standard bank checking or savings account that is maintained at a bank. The deposit account 204 may also take the form of a prepaid debit card associated with a deposit account or some other type of stored value account. The deposit account 204 is typically associated with an account issuer client 206, although a decoupled prepaid debit card may also be used as a deposit account. As used herein, the account issuer client 206 refers to a party or entity which creates and/or issues the deposit account 204 for the accountholder/payee 202. In some embodiments, the account issuer is a traditional bank which creates a bank account for the accountholder/payee 202. In other embodiments, the account issuer client 206 may refer to an issuing bank which has issued a prepaid debit card.

Direct deposit enrollment services in the network environment may be provided by a direct deposit enrollment system 210. The direct deposit enrollment system 210 can be used to initiate a variety of different direct deposit transactions between the payor 208 and the payee 202 using various third party intermediaries 214 and without requiring direct contact and/or cooperation between the payor 208 and the payee 202. The direct deposit enrollment system 210 may be used to provide issuer-effectuated direct deposit enrollments in a variety of ways. However, in each instance, the direct deposit enrollment system is configured to enable the account issuer client 206 to collect the appropriate information (e.g., the necessary payee 202 information) to initiate direct deposit, verify the accuracy and reliability of the collected information, and then transmit the collected information to the appropriate party (e.g., payor 208) in order to complete the direct deposit enrollment.

The network environment 200 also may include a third-party program manager 216 managing a portfolio of deposit accounts 204 pursuant to a business and/or contractual relationship with the account issuer client 206. The third-party program manager 216, on behalf of the account issuer client 206, may be tasked with assisting accountholder/payees 202 in enrolling in direct deposit for their associated deposit accounts 204 using the direct deposit enrollment system 210. To that end, the third-party program manager 216 may collect and access data on behalf of the account issuer client 206, in order to provide the data necessary to the direct deposit enrollment system 210 for creating a direct deposit enrollment transaction. Collectively, the account issuer client 206 and the third-party program manager 216 may be referred to as the enrollment services client 222. The third-party program manager 216 may be the account issuer client itself. The enrollment services client 222 may also be associated with an issuing processor 212. The issuing processor 212 may be associated with the enrollment services client 222. The issuing processor 212 typically provides a processing platform that maintains account balance information and processes payment transactions involving debit cards and other network-access mediums associated with the deposit account 204.

The network environment 200 may also include various communication intermediaries 214. The communication intermediaries 214 are generally entities which facilitate the transmission of a direct deposit enrollment between a payor 208 and the payee 202 using the direct deposit enrollment system 210. More details about the communication intermediaries 214 are provided below in connection with FIG. 5.

The network environment 200 may also include an administrator 218. The administrator 218 may be tasked with maintaining and administering the direct deposit enrollment system 210. The administrator 218 manages the direct deposit enrollment system 210 by creating and maintaining user accounts and permissions for enrollment services clients 222 using the system. The administrator 218 may also participate in setting up enrollment transactions between the direct deposit enrollment system 210 and the payor 208 through the communication intermediary 214.

The direct deposit enrollment system 210 eliminates the requirement that payors 208 and payees 202 directly interface to initiate direct deposit on an account. In doing so, the direct deposit enrollment system 210 allows for more efficient and reliable enrollment of deposit accounts to receive direct deposit of benefits and payments. By creating a network environment 200 suitable for facilitating these enrollment transactions, other parties such as the enrollment services client 222 and issuing processor 212 are able to reap ancillary benefits of the direct deposit enrollment such as increased fee income and revenue.

FIG. 3 provides a more detailed view of the direct deposit enrollment system 210 shown in FIG. 2. In the embodiment shown, portions of the direct deposit enrollment system 210 are situated within a private network 304 which is protected from open access to the Internet by a firewall 302. The use of the private network 304 and the firewall 302 helps to ensure that personal and confidential data is protected by requiring that system users have appropriate and necessary credentials to access the direct deposit enrollment system 210. Within the private network 304 is a web server 306. The web server generates web pages that may be accessed by users of the enrollment system 210 to initiate direct deposit enrollment transactions. The web server 306 may be configured to communicate with a direct deposit enrollment application server 308. The direct deposit enrollment application server 308 may take the form of a middleware application server provides an interface between the web server 306 and a database 310. As will be discussed in detail below, the direct deposit enrollment server 308 includes various modules which provide the ability to generate, process, verify, secure, and store enrollment transactions. In the embodiment shown in FIG. 3, the direct deposit enrollment application server 308 receives data from the web server 306, and based on the data received from the web server 306 may execute one or more application modules and/or initiate database operations (such as SQL queries, for example) on the database 310.

The database 310 may take the form of a relational database that is known in the art. The relational database may be in a format provided by off the shelf database software such as Oracle, MySQL, MS SQL Server or the like. The database 310 may store data related to the direct deposit enrollment transactions initiated by the direct deposit application server 308. For example, the database 310 may include enrollment data 312. The enrollment data 312 includes detailed information about each specific direct deposit enrollment initiated by the direct deposit application server 308, and will be described in further detail in connection with FIG. 6 below.

The database may also store user data 314. The user data 314 generally includes data relating to users of the direct deposit enrollment system 210. These users may include enrollment services clients 222 and the administrators 218. The user data 314 will be described in further detail in connection with FIG. 9 below. In addition, the database 310 may also store event data 316. The event data 316 typically includes information about transactions which take place as part of the direct deposit enrollment process, and will be discussed in additional detail below in connection with FIG. 10.

The database 310 may also store return data 318. Return data 318 is data that is received by the enrollment application server 308 in response to a request by the enrollment application server 308 to the payor 208 to enroll a payee 202 in direct deposit. In most instances, the return data 318 includes error codes and/or transaction codes which indicate whether the enrollment request was successful or not. The return data 318 may be processed by the application server 308 to modify and resubmit a request when the initial request for direct deposit enrollment fails.

In some embodiments, the direct deposit enrollment system 210 may be configured to capture deposit data that results from direct deposit enrollments initiated by the system 210. In these embodiments, deposit data 320 may be captured and stored in the database 310. In some embodiments, the deposit data 320 may be obtained directly from the issuing processor 212, which is typically responsible for posting deposits to deposit accounts 204. In other embodiments, the deposit data 320 may be first obtained by the enrollment services client 216 from the account issuer 206, and then provided to the direct deposit enrollment server 308.

In addition to the database 310, the enrollment server 308 may include encryption processing 322. The encryption processing 322 is generally used to encrypt data before it is stored in the database, and to decrypt data when it is retrieved from the database. The encryption processing 322 allows for stored data to be more secure.

Turning now to FIG. 4, a more detailed view of the direct deposit enrollment application server 308 is provided. As shown, the enrollment application server 308 may include a plurality of APIs 402. Some of the APIs 402 may be enrollment APIs which provide interfaces allowing for enrollment data to be received by the enrollment application server 308 from an external application. For example, an enrollment services client 222 may access an enrollment API to submit enrollment data for an accountholder/payee being enrolled in direct deposit via the enrollment system 210. In some embodiments, enrollment APIs 402 allow for the creation of specific client-side environments which are suited to the needs of the particular client (such as the enrollment services client 222, for example) accessing the enrollment system 210 via the API 402.

The enrollment APIs 402 may be used to collect and compile enrollment data at the client, and then submit the data to the enrollment application server 308 via a series of API calls. In one or more embodiments, the data passed via the API calls includes enrollment data 312. The enrollment application server 308 receives the API data passed from the client and provides the received data to the enrollment processing and verification module 404. The enrollment processing and verification module 404 is configured to appropriately process the received data, as well as verify the credentials of the sender of the data and the accuracy of enrollment data received via the enrollment API 402.

In some embodiments, the processing includes sending the enrollment data to the payor 208. As will be discussed below in connection with FIG. 5, there may be various different types of payors 208 which are handled differently by the enrollment processing and verification module 404. In some instances, the payor 208 may be an employer of an accountholder/payee 202 such that the processing may include transmitting the received data through a communication intermediary such as a payroll processor 502, or some other intermediary 214. In other embodiments, the payor 208 associated with a submitted enrollment may be the U.S. Treasury, which owes a benefit (such as a Social Security check) to the payee 202. In these instances the processing may involve transmitting an enrollment request via a different communication intermediary 214. In still other scenarios, a communication intermediary 214 may be unnecessary, and the processing module 404 will send data directly to the payor 208. It is to be appreciated, of course, that the enrollment application server 308 may perform various additional steps in the course of processing the enrollment.

Generally, the payor 208 or other party receiving the enrollment data will perform its own processing on the enrollment data. If the enrollment request encounters errors, a return code may be provided to the enrollment application server 308 which is indicative of the error. For example, if an enrollment is transmitted via the Fedwire 504 of the ACH network to the federal government, and the ACH network request is refused, a return code may be sent to the enrollment application server 308 notifying it of the failed request. The enrollment application server 308 may include a return processing and verification module 406 which is configured to process and verify returns. If a return code indicates an error, the return processing module 406 may correct the error automatically and make a second request to the payor 208. Alternatively, the return processing module 406 may also ask the enrollment services client 222 which submitted the enrollment to take corrective action. If the return data contains no errors, an API response may or may not (depending on the processing protocol of payor 208) be sent back to the requesting party indicating that a successful enrollment transaction took place.

In addition to providing APIs 402 which allow external applications to interface with it, the application server 308 may also include one or more user interfaces 408 which allow a user to access the system via the web server 306. The user interfaces may include an administrator portal, a client portal, and a self service enrollment portal. The administrator portal include a user interface which allows the administrator 218 to create and manage user accounts, define reports, and perform other administrative tasks as required by the enrollment system 210. The client portal, which will be described in detail below, provides the enrollment services client 222 with the ability to view and modify enrollments, determine enrollment status, view deposit data, and the like. In addition, a self service enrollment portal may be defined which allows the payee 202 himself to submit a direct deposit enrollment request to the payor 208.

In some instances, an enrollment services client 222 using the enrollment system 210 may not choose to use (or may not have available to it) an API 402 to provide payee data for initiating a direct deposit enrollment. In these instances, in addition to (or in conjunction with) the user interfaces 408, a forms library 410 may be used to provide an input mechanism for enrollment data. The forms library may include one or more forms which allow a user to submit enrollment data to the enrollment application server 308 via web form pages served by the web server 306. The forms library 410 provides a convenient and accessible alternative to using the API services.

Additional APIs 402 may also be provided which allow the application server 308 to easily receive and process return data. For example, the application server may include an API which allows it to receive return codes from a communication intermediary 214 or payor 208 directly to store as return data 318. In addition, the application server 308 may also utilize an API to obtain deposit information from the issuing processor 212 to store as deposit data 320.

When a direct deposit enrollment has been successfully initiated, in some embodiments, the enrollment server 308 may be configured to track deposits made to deposit accounts 204. In order to track deposits, the enrollment server 308 includes a deposit processing and verification module 412. The deposit processing and verification module 412 may serve two purposes. First, it may be used to capture pre-notes to validate that a particular enrollment has been accepted by the payor 208. If a payor 208 has pre-noted a deposit account 204, it is an indication that the enrollment has been accepted by the payor 208. The pre-note data may include the zero dollar amount and the pre-note date and the payor information. In addition, deposit data may be also be captured in order to track total deposits achieved for a particular accountholder. This information allows the enrollment services client 222 to view and analyze the impact of their direct deposit enrollment activities, the enrollment/deposit lifecycle of their accountholder/payees 202 so that they may better understand and support them. The application server 308 may also include an accountholder support module 414. The accountholder support module 414 provides assistance to accountholders/payees 202 wishing to effectuate direct deposit enrollment via the direct deposit enrollment system 210. Lastly, the application server 308 may also include a fraud protection module 416. The fraud protection module 416 is generally configured to analyze enrollment data received by the server, and verify enrollments through prescreening and enrollment blocking techniques. The fraud protection module 416 will be discussed in additional detail below in connection with FIGS. 7-9.

Turning now to FIG. 5, a more detailed view of data and process flow that takes place in a direct deposit enrollment is provided. As shown, the enrollment services client 222 initially requests permission from the accountholder/payee 202 to enroll them in direct deposit, and the accountholder/payee 202 provides his authorization, along with the necessary details to effectuate the enrollment. It should be appreciated that the enrollment services client 222 may already have most, if not all, of the necessary information from the payee 202 based on its relationship with the account issuer 206 and the issuing processor 212. The enrollment services client 222 accesses the direct deposit enrollment system 210 and provides it with the enrollment request data. The enrollment system, in turn, generates and submits an appropriate enrollment request based on the type of payment/benefit that is owed to the payee 202.

Depending upon the type of benefit and the nature of the payor, the process flow undertaken by the enrollment system 210 will differ. In the example shown in FIG. 5, four different scenarios are shown: (1) employer/employee payroll enrollment; (2) federal benefit enrollment; (3) state benefit enrollment; and (4) insurance annuity enrollment. A skilled artisan will appreciate, however, that various other payor/payee scenarios can exist, and that the particular examples shown in the figure should not be considered as limiting.

In the first employer/employee payroll enrollment scenario, the enrollment system 210 may utilize a communication intermediary 214 such as a payroll processor 502. The enrollment system 210 may communicate the enrollment request to the intermediary payroll processor 502, which in turn confirms the request with the employer 506 (who is the actual payor 208). In the federal benefit enrollment scenario, an intermediary 214 may also be used. In this scenario, the payor 208 is the U.S. Treasury 508, and the intermediary is the Fedwire 504 provided by the Treasury 508 for conducting ACH transactions. Thus, the enrollment request is sent to the Treasury 508 via the Fedwire 504 to effectuate the enrollment.

In the third scenario outlined in FIG. 5, the enrollment system is configured to handle a direct deposit enrollment request relating to a state benefit (such as an unemployment benefit, for example). In this context, the benefit may be a state directed benefit or a non-state directed benefit. For a non-state directed benefit, the enrollment request may be send using a form library with automatically populated accountholder data and an embedded electronic signature obtained from the accountholder/payee 202. In the case of a state directed benefit, the system 210 may direct the accountholder/payee 202 to send an enrollment request via a form provided on the state website accompanied by an instructive overlay with accountholder data. In either case, the use of an intermediary 214 is unnecessary, and the enrollment system 210 is configured to facilitate the effort of the accountholder/payee 202, capture the appropriate enrollment request data 312 into the state form and submit it to the state agency 510 directly for processing and enrollment.

In the fourth scenario, the enrollment request relates to an annuity paid by a pension provider 512. Here, the request by the enrollment system 210 may be generated to confirm to a predefined API that allows the request to be submitted directly to the pension provider 512. Alternatively, if the pension provider 512 utilizes a payment processor as a communication intermediary (not shown in FIG. 5), the request may be sent to the payment processor. As can be seen, there are many different ways in which the enrollment system may process data to effectuate direct deposit enrollments on behalf of the enrollment services client 222.

As noted above, the database 310 may receive enrollment data 312 via the application server 308 from either an accountholder 202 directly via the self service enrollment portal or an enrollment services client 222. FIG. 6 is a more detailed view of the enrollment data 312 that may be stored in the database 310. As noted previously, the enrollment data 312 generally includes data related to a specific enrollment in direct deposit services provided by payors 208 (either directly or in cooperation with intermediaries 214 such as payroll processor 502). The enrollment data 312 may include accountholder data 602. The accountholder data 602 typically includes information relating to the accountholder who wishes to enroll in direct deposit. This information may include an account number for the deposit account 204 associated with the customer. This information may also include the customer's name, address, e-mail, and other personal information.

An enrollment may also be associated with a particular program profile defined on behalf of an enrollment services client 218. The enrollment data 312 may include program profile data 604. The program profile data 604 may include information such as the routing number associated with the program, the branding associated with the program, and other program specific information. Also included in the enrollment data is the payment data 606. The payment data 606 is data which describes the details of the particular payments that are to be made in connection with a direct deposit enrollment. For example, the payment data 606 may include the payment type 608 (e.g., payroll, annuity, federal benefit, state benefit, etc.); beneficiary data 610 in cases where the accountholder/payee 202 may have a fiduciary relationship with the beneficiary and receive payments on its behalf; third-party intermediary information 612 for those situations where the direct deposit is performed by a third party intermediary 214 on behalf of the payor 208 (e.g., payroll processor 216); and specification of the allocation percentage 614 where a payee 202 wishes to direct deposit only a portion of payment to the designated deposit account 204.

FIG. 7 is a more detailed view of the fraud protection module 416. The fraud protection module 416 may be configured to apply multi-tiered protection against fraudulent direct deposit enrollment activity. The fraud protection module 416 may include various submodules. For example it may include a prescreening module 702. The prescreening module 702 is typically configured to perform pre-qualification checks on in rolling accountholders. These pre-qualification checks may include the use of a customer identification program (“CIP”), which may be defined by the account issuer initiating the enrollment. The pre-qualification checks may also include the use of out-of-wallet questions which may be presented to the accountholder in order to verify their identity. However, it should be appreciated that in cases of identity theft, these measures may be insufficient to detect a fraudulent enrollment.

The fraud protection module 416 may also include an enrollment blocking module 704. The enrollment blocking module 704, which is discussed in additional detail below in connection with FIG. 8, is generally configured to verify direct deposit enrollments against filtering criteria and historical dated checks. The filtering criteria may, in some embodiments, be issuer-defined filtering criteria. The enrollment blocking module 704 may be configured to automatically block enrollments which do not meet the criterion required for verification. When an enrollment is blocked, it typically will not eat processed unless the issuer independently verifies the enrollment information, and removes the block from the enrollment in question.

The fraud protection module 416 may also include an audit documentation module 706. The audit documentation module 706 may take the form of an integrated document retrieval service which permits account issuers to upload, store, and view supporting enrollment acceptance documentation that verifies the authenticity of an enrollee.

Finally, the fraud protection module 416 may also include a fraud data storage and detection module 708. The fraud data storage and detection module 708 may take the form of data storage which is configured to store information about events and incidences of potential fraudulent enrollments. In addition, and as will be explained later in more detail, the fraud data storage and detection module may be configured not only to store information about detective fraud, but also information about enrollments which appear to have failed due to reasons other than fraud. By doing so, a significant body of data may be collected and utilized to provide visibility into direct deposit enrollment across multiple account products and issuers.

FIG. 8 is a more detailed of the enrollment blocking module 704. As mentioned above, the enrollment blocking module 704 may be generally configured to verify enrollments against filtering criteria and historical data. In this particular example, we enrollment blocking module 704 includes general enrollment blocking criteria 802. This general enrollment blocking criteria may be defined globally within the system, and may apply to all enrollments processed by the enrollment blocking module 704. The general criteria 802 may be a set of minimum standards that must be met by all enrollments. The enrollment blocking module 704 may also include issuer defined filtering criteria 804. As shown, various account issuers 806 may define specific enrollment criteria which will be applied to those enrollments initiated by each specific account issuer. For example, account issuer no. 1 may have a set of criteria 804 defined and associated with it as shown in the figure, whereas account issuer no. 2 may have a different set of criteria 804 defined and associated with it. Thus each account issuer may be provided the opportunity to define those filtering criteria which best suit its needs. In addition, because the direct deposit application server 308 handles all of these different enrollment blocking criteria, the general enrollment criteria 802 may be enhanced by analyzing the effectiveness of issuer specific enrollment blocking criteria at combating identity theft in direct deposit enrollments.

Turning now to FIG. 9, a more detailed view of the fraud data storage and detection module 708 is provided. As discussed above, this module is typically configured to store information relating to events which trigger protection against fraudulent direct deposit enrollment activity, or otherwise relate to failed enrollments. As shown, the fraud data storage and detection module 708 may include invalid benefits request data 902. The invalid benefits requests data 902 may include data relating to enrollment requests which fail for any of a number of reasons. For example it may include data relating to enrollment requests in which the prospective enrollee failed to properly identify a benefit for which they were eligible. The invalid benefits request data 902 may also include data regarding unsuccessful row enrollments which were blocked due to suspected fraudulent activity. Still further, this data may include records relating to failed pre-qualifications of enrollees. In short, the invalid benefits request data 902 may generally store data that relates to failed enrollments.

The fraud data storage and detection module 708 may also include data which identifies flagged accounts 904. The flagged account data 904 generally includes information which identifies accounts which appear to be suspicious or otherwise have been shown to be associated with fraudulent direct deposit enrollment activity. For example, when a specific pre-paid card has been used to attempt to fraudulently obtain a direct deposit enrollment, this card may be flagged in the flagged account data 904. In addition to flagging problematic accounts, the fraud data storage and detection module 708 may also flag specific identities. To that end, a flagged identifiers data store 906 may be maintained. The flagged identifiers data 906 may include information such as Social Security numbers which have been involved in potentially fraudulent direct deposit activity.

FIG. 10 is a flowchart providing an illustration of a process for blocking a direct deposit enrollment in accordance with one or more embodiments. The process begins at block 1002 where the system receives a direct deposit enrollment request. Having received the enrollment request, the process then moves to block 1004, where the enrollment request is processed by the system. Once the enrollment request has been processed by the system, the process then moves to block 1006. There a prescreening security check is run against the enrollment request data. As discussed above, the prescreening security check may include verification solutions which attempt to prequalify account holders with CIP and/or out of wallet questions.

The process next moves to decision block 1008, where it is determined whether the enrollment passes the prescreening security check. If not, the process moves to block 1020 and the enrollment is blocked. However, if the enrollment passes the prescreening, the process then moves to block 1010. There, the system compares the enrollment data to the general enrollment blocking criteria defined in the system. The process then moves to decision block 1012 where the system checks to see if the account issuer involved in the enrollment has issuer-specific enrollment criteria which is additional to the general enrollment criteria. If not, the process skips ahead to block 1018 and the enrollment is permitted to continue. If the account issuer does have issuer specific enrollment criteria, the process instead moves to block 1014, where the system executes the account issuer enrollment criteria against the enrollment package received for the enrollment. The process then moves to decision block 1016, where it is determined whether the enrollment is valid in view of the account issuer specific enrollment criteria. If so the process moves directly to block 1018 in the enrollment continues. However, if the account issuer specific enrollment criteria is not satisfied, the process instead moves to block 1020, and the enrollment is blocked because it failed to meet the necessary criteria.

As stated above, direct deposit enrollments may be blocked for a variety of reasons. Information about those blocked direct deposit enrollment attempts may be stored in a database for further use and analysis. Turning now to FIG. 11, a flow diagram provides one of how a direct deposit enrollment attempt may be rejected and/or blocked due to the ineligibility of the account holder for the benefit sought. The process begins at block 1102. There, the system receives a direct deposit enrollment request from an account holder. The request is a request for enrollment in direct deposit for a federal benefit received by the user. Examples of federal benefits may include Social Security checks, welfare checks, and the like. The process then moves to block 1104, where the system determines that the account holder is not eligible for the benefit sought. As a result, the process moves to block 1106 and the enrollment is rejected and/or blocked due to ineligibility on the part of the account holder for the benefit sought. Once the enrollment has been rejected and/or blocked, a record of the rejected and/or blocked federal benefit enrollment is stored in the database as invalid benefits request data 902.

The invalid benefits request data 902 may be used as a screening parameter to identify potentially fraudulent direct deposit requests which otherwise may go undetected. In particular, utilizing the systems and methods disclosed herein, the inventors have recognized that a common tactic of identity thieves is to attempt to register for federal benefits received by the identity theft victim. However, in many cases the identity thief does not know exactly which benefits the victim receives. As a result, the identity thief simply attempts to register for direct deposit of several different federal benefits from various different account issuers, in the hopes that one or more of them is successful. These types of fraudulent activities have been difficult to detect using prior systems. However, utilizing the invalid benefits request data 902 generated by the process described in FIG. 11, these types of fraudulent enrollments may be detected and stopped.

FIG. 12 is a flow diagram of a process by which these types of fraudulent activities can be detected and stopped. The process begins at block 1202, where the system receives a direct deposit enrollment request from an account holder for federal benefit. The process then moves to block 1204, where the system checks to determine whether the account holder is eligible for the requested benefit. The process then moves to decision block 1206, where it is determined whether the account holder is eligible for the requested benefit. If the account holder is not eligible for the requested benefit the process jumps to block 1214, where the enrollment in that federal benefit is denied. If, however, at decision block 1206 it appears that the account holder is eligible for the benefit the process moves to block 1208, where the system checks the database, and in particular the invalid benefits request data 902 four prior failed benefit enrollments by the account holder. The process then moves to decision block 1210. There, if prior failed enrollments are found, the process moves to block 1214 where the enrollment is halted. If no failed enrollments are found at decision block 1210, the process moves to block 1212 in the enrollment is permitted. Turning back to block 1214, where the enrollment is denied, the process moves from there to block 1216. There, a record of the blocked enrollment is added to the fraud data 708.

By adding the data about the blocked enrollment to the fraud data 708, a negative list comprised of suspicious accounts, account holders, and third-party deposit beneficiaries may be created. The list provides visibility into direct deposit enrollment across multiple account products and account issuers. The list may be leveraged to identify suspicious activities and allow account issuers to detect potentially fraudulent enrollments based on data collected by other account issuers. In some embodiments, this data may be used to identify potentially fraudulent enrollments after they have already been approved. For example, if an identity thief successfully avoids detection and is permitted to enroll in direct deposit for a first federal benefit, subsequent failed attempts to enroll in federal benefits may be used to call into question the validity of the initial enrollment. Thus, using the systems and methods is closed herein, fraudulent direct deposit enrollments which initially escape scrutiny may be detected and stopped by providing a second level of analysis.

Utilizing the embodiments described above, a flexible and efficient method for direct deposit enrollment of accountholders is provided to account issuers. Nevertheless, those of skill will recognize that the various illustrative logical blocks, modules, circuits, and algorithm steps described in connection with the embodiments disclosed herein may be implemented as electronic hardware such as a general purpose or special purpose computer, computer software, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A method of detecting fraudulent direct deposit enrollments, the method comprising:
receiving and storing direct deposit enrollment request data for a plurality of account holders on behalf of multiple account issuers;
pre-screening accountholders based on receiving and storing personal data regarding the enrolling accountholder and verifying said data against public record information;
pre-screening beneficiaries based on receiving and storing personal data regarding the beneficiary and verifying said data against public record information;
determining whether the account holder is eligible for the requested deposit;
analyzing the stored data to determine whether the enrollment data matches identified fraudulent enrollment patterns;
analyzing the stored data to determine whether prior blocked benefit enrollment requests exist for the requesting account holder;
blocking suspected fraudulent enrollments and storing additional data indicative of the blocked enrollment and the account holder;
communicating to the account issuer the blocking of a direct deposit enrollment;
enabling the account issuer to screen actual direct deposit data received associated with blocked accounts, account holders and beneficiaries; and
enabling the account issuer to screen actual direct deposit data received that is inconsistent with data obtained via the direct deposit enrollment process.

2. The method of claim 1, wherein the identified fraudulent enrollment patterns are determined at least in part by:
receiving direct deposit enrollment requests from the plurality of account holders;
determining, for the requests, whether the account holder making the request is not eligible for the requested benefit;
blocking requested enrollments if it is determined that the account holder is not eligible; and
storing a record for each blocked enrollment.

3. The method of claim 2, where in the record is stored as fraud detection data.

4. The method of claim 1, wherein storing additional data indicative of the blocked enrollment and the account holder comprises:
adding data indicative of the identity of the account holder associated with the blocked enrollment to a first negative list comprising flagged identities.

5. The method of claim 4, wherein storing additional data indicative of the blocked enrollment and the account holder comprises:
adding data indicative of the account associated with the account holder to a second negative list comprising flagged accounts.

6. A system for detecting fraudulent direct deposit enrollments, comprising:
data storage comprising data indicative of blocked requests for enrollment in direct deposit for a benefit by a plurality of account holders;
a processor configured to:
receive and store direct deposit enrollment request data for a plurality of account holders on behalf of multiple account issuers;
pre-screen accountholders based on received and stored personal data regarding the enrolling accountholder and further based on a verification of said data against public record information;
pre-screen beneficiaries based on received and stored personal data regarding the beneficiary and further based on a verification of said data against public record information;
determining whether the account holder is eligible for the requested deposit;
analyze the stored data to determine whether the enrollment data matches identified fraudulent enrollment patterns;
analyze the stored data to determine whether prior blocked benefit enrollment requests exist for the requesting account holder;
block suspected fraudulent enrollments and store additional data indicative of the blocked enrollment and the account holder;
communicate to the account issuer the blocking of a direct deposit enrollment;
enable the account issuer to screen actual direct deposit data received associated with blocked accounts, account holders and beneficiaries; and
enable the account issuer to screen actual direct deposit data received that is inconsistent with data obtained via the direct deposit enrollment process.

7. The system of claim 6, wherein the identified fraudulent enrollment patterns are determined at least in part by the processor being configured to:
receive direct deposit enrollment requests from the plurality of account holders;
determine, for the requests, whether the account holder making the request is not eligible for the requested benefit;
block requested enrollments if it is determined that the account holder is not eligible; and
store a record for each blocked enrollment.

8. The system of claim 7, where in the record is stored as fraud detection data.

9. The system of claim 6, wherein the processor is configured to store additional data indicative of the blocked enrollment by adding data indicative of the identity of the account holder associated with the blocked enrollment to a first negative list comprising flagged identities.

10. The system of claim 9, wherein the processor is configured to store additional data indicative of the blocked enrollment by adding data indicative of the account associated with the account holder to a second negative list comprising flagged accounts.
